(19) United States
(12) Patent Application Publication
(10) Pub. No.: US 2025/0020576 A1
(43) Pub. Date: Jan. 16, 2025

(54) Clamshell Analyzer for Static or Flowing Samples

(71) Applicant: Nirrin Technologies, Inc., Billerica, MA (US)

(72) Inventors: Bryan A. Hassell, Cambridge, MA (US); David P. Marchessault, Hopkinton, MA (US)

(21) Appl. No.: 18/767,034

(22) Filed: Jul. 9, 2024

Related U.S. Application Data
(60) Provisional application No. 63/512,996, filed on Jul. 11, 2023.

(51) Int. Cl. G01N 21/05; G01N 21/35; G01N 21/39

(52) U.S. Cl. CPC G01N 21/05; G01N 21/35; G01N 21/39; G01N 2021/052; G01N 2201/0224; G01N 2201/0683

(57) ABSTRACT

A system for analyzing a sample, e.g., by NIR, includes a clamshell apparatus and a tunable laser. The apparatus has a fixed first section and a second section which can move between an open position and a closed position. A sample detection region is formed between an input rod and an output rod by lowering the second section to the closed position. A flowcell inserted between these sections can be used to analyze flowing samples. One illustrative arrangement employs a reference detector positioned in the first section and a sample detector positioned in the second section.

### RELATED APPLICATIONS

This application claims the benefit under 35 U.S.C. § 119 (e) of U.S. Provisional Application No. 63/512,996, filed on Jul. 11, 2023, which is incorporated herein by reference in its entirety.

### BACKGROUND OF THE INVENTION

Many processes in the chemical, biochemical, pharmaceutical, food, beverage and in other industries benefit from some type of analysis. Of particular importance is the identification and often the quantification of substances present. One common technique involves obtaining a sample and detecting one or more of its components, sometimes referred to as analytes.

Analytes can be assessed by various optical spectroscopy approaches. Among these, probably the most common is absorption spectroscopy. Incident light excites electrons of the analyte from a low energy ground state into a high energy, excited state, and the energy can be absorbed by both non-bonding n-electrons and π-electrons within a molecular orbital. Absorption spectroscopy can be performed in the ultraviolet, visible, and/or infrared region, with analytes of varying material phases and composition being interrogated by specific wavelengths or wavelength bands of light. The resulting transmitted light is then used to resolve the absorbed spectra, to determine the analyte's or sample's composition, temperature, pH and/or other intrinsic properties for applications ranging from medical diagnostics, pharmaceutical developments, food and beverage quality control, to list a few.

Many existing instruments use light in the visible and/or ultraviolet (UV) region of the electromagnetic spectrum. For the past decade, for example, UV-Visible systems have been the gold standard for measuring protein and monoclonal antibodies (mAb) concentrations. However, the accuracy and reproducibility of UV-visible equipment can suffer from dynamic range limitations due to extremely strong absorption by proteins in the UV region, with typical maximum absorptions of about 3 to 4 absorbance units (AU). A partial solution was the development of systems that utilize variable pathlengths.

In U.S. Patent Application Publication No. 2019/0358632A1, Hassell et al. describe analyses of culture media using near infrared (NIR) spectroscopic techniques.

Applications of NIR-based techniques to measurements of samples in a flowcell are described in U.S. Patent Application Publication No. 2020/0240902A1, to Hassell et al.

U.S. Pat. No. 11,499,903 to Hassell et al. describes robust, hands-free, non-destructive, real-time NIR techniques for identifying and/or quantifying constituents in a given process, using an in-situ probe that can be inserted and/or maintained in a bioreactor.

### SUMMARY OF THE INVENTION

Even with the advantages obtained with in-situ monitoring, for many applications sample collection and sample analysis are conducted independently of one another. For instance, samples withdrawn from a reactor or obtained from another source often are analyzed using a bench-type instrument, in a laboratory or industrial setting, for example.

A need continues to exist, therefore, for developing analysis equipment that does not employ an in-situ probe.

Also needed are systems and methods that address limitations associated with existing UV-visible spectroscopic analyzers, such as, for instance, problems raised by current variable pathlength approaches. Variable pathlength limitations are particularly pronounced at later stages in downstream processing, often characterized by very high mAb concentrations (e.g., >10 mg/mL). As concentration of the mAb increases, pathlength must decrease to accommodate the sensor saturation limit. However, pathlength reproducibility at very small lengths (less than 100 micrometers or microns (μm), for example) is difficult to achieve.

Recognizing the advantages associated with NIR spectroscopic techniques, a need also exists in developing instrumentation that realizes these advantages. Systems that facilitate or even enhance NIR analytical approaches or expand these approaches into the mid-infrared (MIR) range are of great interest.

Particularly desired are instruments that do not rely on variable pathlength approaches. Also desired is the versatility of handling both static and flowing state analyses with a single instrument. Simplified approaches that do not require complex moving stages or dilution continue to be of interest.

Turning to a specific field, a consistent trend for many therapeutics is a push towards higher concentrations due to the improved pharmacokinetics/dynamics. Thus, a great number of the FDA-approved mAb therapies involve high concentration formulations (>100 mg/mL). It is desirable, therefore, to implement measurement and quantitation technologies that are designed and capable of performing in this higher concentration range.

In general, the invention pertains to an apparatus, system and/or method that solve at least some of the problems and/or address needs noted above.

In one of its aspects, the invention features an apparatus having a “clamshell” design, in which the apparatus opens to receive a sample and then closes over the sample to perform the analysis. The apparatus can be constructed from two sections, halves, parts or portions, at least one section being configured for opening and closing in clamshell (or flip) fashion. The movement can be realized through a connection that joins the two sections directly or via an intermediary support or base.

In specific embodiments, some components are arranged in a first section, often the lower or bottom part, that is fixed onto a support. A second section, often the upper, top or “lid”-like part houses other components and is configured to move or “flip” between an open and closed position. During operation, the apparatus can be placed in the open position to introduce a sample, for example. Closing the second (e.g., upper) section brings the two sections together, forming a sample detection region, also referred to herein as a sample “gap”. Absorption spectra of sample analytes present in the sample detection region can be obtained while the apparatus is in the closed configuration.

The sample gap can be formed between rods that transmit light in the desired region of the electromagnetic spectrum, e.g., the NIR, SWIR or MIR. Some approaches employ rods designed and/or oriented to reduce or minimize reflections/etalons. In specific implementations, the gap (and thus also the light pathway) has fixed dimensions. In one example, the gap is set and maintained at a fixed pathlength for a given measurement. Some construction details allow for resetting the pathlength as a new or different sample is analyzed. The pathlength (gap) can have a value within a range of from about 0.010 millimeters (mm) to about 10 mm. In illustrative implementations, the pathlength has a value within a range of from about 0.010 mm to about 5 mm.

For many arrangements, the first (e.g., lower) section houses elements for directing light, typically from a light source, e.g., a laser, to the sample gap, while the second (e.g., lid-like) section houses elements for detecting the light once it has traversed the sample gap, also referred to herein as the “transmitted” light.

The clamshell apparatus can be employed to study static samples. Such samples are introduced to the sample detection region (as drops from a pipette, for instance) and remain at rest until they are removed, e.g., by an operator.

Analytes in a flowing medium can be addressed as well. Thus, specific aspects of the invention feature a clamshell apparatus that includes a flowcell. One implementation relies on an adapter, typically a plate that defines an interior channel for bringing a flowing sample to and from a sample detection region. The adapter can be placed onto the first (often the fixed) section of the clamshell apparatus and forms an insert when the apparatus is in its closed configuration.

A clamshell apparatus designed for analyzing static samples can be permanently retrofitted to handle flowing samples. In many cases, however, the apparatus can be switched between analyzing static and flowing samples.

The apparatus can be part of a system that also includes a laser, a tunable laser, for example. Thus, in one of its aspects, the invention features a system that includes a clamshell apparatus and a tunable laser for generating a swept wavelength signal. A first section of the clamshell apparatus includes components for directing light from the laser to a sample detection region; a second section includes a photodetector for detecting the swept wavelength signal after transmission through the sample detection region. In some implementations, the first section further includes a detector for detecting the swept wavelength signal prior to transmission through the sample.

For a laser that is external to the clamshell apparatus, the system can employ fiber optic technology to transmit light to the first section of the apparatus.

In a further aspect, the invention features a method for analyzing a sample. The method comprises generating a swept wavelength signal; transmitting the swept wavelength signal through a first section of a clamshell apparatus, to and though a sample detection region; detecting the swept wavelength signal after transmission through the sample detection region in a second section of the clamshell apparatus: and resolving an absorption spectrum of the sample. These steps are conducted with the apparatus in a closed configuration. In some embodiments, the clamshell apparatus is opened to load the sample being analyzed.

The method can also include detecting the swept wavelength signal prior to transmission through the sample detection region and resolving an absorption spectrum of the sample with reference to the swept wavelength signal before and after transmission through the sample detection region.

Conducting measurements on static samples is described in in International Publication No. WO 2024/102825, filed on Nov. 8, 2023, incorporated herein by this reference in its entirety.

To analyze a flowing sample, the sample can be introduced and guided through the clamshell apparatus using a flow cell. As it progresses through the flowcell, the sample passes through a sample detection region where it can be scanned. The flowcell forms or is part of an insert, referred to herein as a “flowcell adapter” or simply as an “adapter”, which is located between the two sections of the clamshell apparatus in its closed position.

In some cases, the sample flows through the sample detection region in a continuous mode. It is also possible to interrupt the sample flow for a desired time interval, to obtain a measurement, for example.

The method and apparatus described herein can be operated within a desired wavelength region, such as, for instance, in the NIR through MIR. In specific examples, the wavelength is within a range of from about 1350 to about 1800 nanometers (nm) or within a range from about 2050 to about 2400 nm. For MIR analyses the wavelength can be within a range from about 3.5 to about 10 microns. One example employs a widely tunable quantum cascade laser (QLC). Light sources that emit wavelength signals of different electromagnetic energies also can be employed. In one implementation, the light source is a UV/visible tunable laser.

In one application, the apparatus, the system and/or the method described herein are used in protein manufacturing, in particular in downstream process steps, where protein concentrations are high. In such regimes, approaches described herein present a marked advantage over UV-visible measurements. At mAb concentration of 10 mg/mL and higher, for example, typical UV-visible protocols require dilutions. In contrast, the apparatus, system or method described herein yields accurate, linear results, without need for complex protocols, moving stages, variable pathlengths or the need for dilutions. In many cases a 15 μL sample volume is sufficient to run the analysis.

Practicing embodiments described herein can lead to increased accuracy relative to existing approaches. Applying principles of the invention to mAb measurements can result in a 1% error for concentrations of 0.1 to 1000 mg/mL. High versatility is yet another benefit. In addition to measurements of mAb concentrations of 0.1 to about 1000 mg/mL, it is possible to simultaneously measure excipients such as histidine, arginine, methionine, polysorbate, sucrose, to name a few. In one example, measurements were conducted with a commercial product at a concentration of 313 mg/mL. All measurements can be carried out using one system and, typically, a single scan. To illustrate, in addition to measuring mAb, histidine can be measured at 1 to 100 mg/mL concentrations, while polysorbate can be measured at 1 to 2 mg/mL concentrations.

In some implementations, such as mAb measurements, for example, spectra are consistent and unique regardless of background. This is a significant improvement relative to UV-visible techniques which rely on analytics or curve fitting to an extinction coefficient for measurement; such an approach may be adversely affected by the presence of excipients in the background.

Instruments that can handle both static and flowing measurements reduce capital investment, equipment footprint and maintenance, while greatly expanding the realm of potential applications. A detachable flow cell adapter such as described herein offers the flexibility of switching between static and flowing samples with the same clamshell apparatus. As seen below, switching between the two modes can be implemented quickly and easily, by simply adding or removing the adapter.

Durable and highly reliable, equipment and techniques according to the invention can provide repeatable results that are easy to validate. Measurements can be very rapid (seconds), often 50 times faster than those available with competing technologies. In many cases, the scan time is about 5 seconds.

Easy to use instrumentation involves a simple workflow, with minimal or no setup or calibrations. The analysis too is far from complicated and can be conducted without input from highly skilled personnel. As a result, the equipment and methods described herein can offer competitive pricing for capital and service.

The rod arrangement relied upon in some implementations replaces the cuvettes typical of existing instrumentation, reducing the need for consumables. Even protocols that call for glassware wash and reuse involve extra effort. Also, since cuvettes can display changes in thickness, depending on the particular cuvette, and even depending on where the scan is performed in the same cuvette, quality of the analysis can suffer. Moreover, cuvette designs rely on parallel or nearly parallel surfaces that can cause massive etalons/reflections.

Reducing the need for other consumables (reagents, for instance) or that of outsourcing excipient measurements can further contribute to cost effectiveness.

Techniques such as the ones described herein also improve the quality of the analysis. For example, embodiments described herein can provide improved or even maximum signal to noise ratios (SNR). This is accomplished by launching a light beam straight out of a fiber and/or a free space link, through a sample gap, with the transmitted light impinging onto a photodetector. Having the detector cables running back to the spectrometer (rather than using a return fiber optic cable leading to a photodiode) removes a source of noise.

The above and other features of the invention including various novel details of construction and combinations of parts, and other advantages, will now be more particularly described with reference to the accompanying drawings and pointed out in the claims. It will be understood that the particular method and device embodying the invention are shown by way of illustration and not as a limitation of the invention. The principles and features of this invention may be employed in various and numerous embodiments without departing from the scope of the invention.

### BRIEF DESCRIPTION OF THE DRAWINGS

In the accompanying drawings, reference characters refer to the same parts throughout the different views. The drawings are not necessarily to scale; emphasis has instead been placed upon illustrating the principles of the invention. Of the drawings:

FIG. 1 is a perspective view of an upper section of a clamshell apparatus supported on a cabinet-like base;

FIG. 2 is a view of a system including a clamshell apparatus, shown in cross section, in an open position;

FIGS. 3A and 3B are views of a system including a clamshell apparatus shown in cross section, in a closed position;

FIG. 3C is a top view showing a different reference detector layout;

FIG. 4A is a side perspective view showing rods forming a sample detection region;

FIG. 4B is a side perspective view of a cross-section showing the rods of FIG. 4A rotated from each other by an angle of 90 degrees (°) around the longitudinal axis;

FIG. 5 is a cross sectional view of a portion of a clamshell apparatus showing specific geometry and orientation of the rods forming a sample detection region;

FIG. 6A is a schematic diagram of a light beam traveling through rods constructed and orientated as shown in FIGS. 4A and 4B;

FIG. 6B is a graph showing the absence of overlap between the main beam and a secondary beam obtained using the rods constructed and oriented as shown in FIGS. 4A and 4B;

FIG. 6C is a plot of the effective etalon strength with reflection through water as a function of the angle between beams θ;

FIGS. 7A, 7B and 7C are views of an adapter that can be incorporated in a clamshell apparatus for flowcell applications;

FIG. 8 is a perspective view of a clamshell apparatus, in an open position, including a flowcell adapter;

FIG. 9 is a top view of a flowcell adapter supported on a lower section of the clamshell apparatus of FIG. 8;

FIG. 10 is a side cross-sectional view of a flowcell adapter held between two sections of a clamshell apparatus in its closed configuration;

FIG. 11 is a front cross-sectional view of a flowcell adapter held between two sections of a clamshell apparatus in its closed configuration;

FIG. 12 presents data identifying several analytes (mAb, histidine and polysorbate) in a single scan;

FIG. 13 compares UV-visible absorbance as a function of mAb concentration to the absorbance obtained by practicing embodiments of the invention;

FIG. 14 shows the spectral signature of a commercial mAb which is identical to the NIST mAb reference (A) and scales through dilutions (B, C and D);

FIG. 15 compares the error observed with UV analysis and with the error seen with techniques described herein through various dilutions;

FIG. 16A presents the spectral deconvolution identifying components in a sample containing sucrose, histidine and histidine HCl;

FIG. 16B presents the spectral deconvolution identifying components in a sample containing arginine and histidine HCl; and

FIGS. 17A, 17B, 17C and 17D are spectra of buffer components that can be quantified by techniques and/or equipment described herein.

### DETAILED DESCRIPTION OF THE PREFERRED EMBODIMENTS

The invention now will be described more fully hereinafter with reference to the accompanying drawings, in which illustrative embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art.

As used herein, the term “and/or” includes any and all combinations of one or more of the associated listed items. Further, the singular forms and the articles “a”, “an” and “the” are intended to include the plural forms as well, unless expressly stated otherwise. It will be further understood that the terms: includes, comprises, including and/or comprising, when used in this specification, specify the presence of stated features, integers, steps, operations, elements, and/or components, but do not preclude the presence or addition of one or more other features, integers, steps, operations, elements, components, and/or groups thereof. Further, it will be understood that when an element, including component or subsystem, is referred to and/or shown as being connected or coupled to another element, it can be directly connected or coupled to the other element or intervening elements may be present.

Unless otherwise defined, all terms (including technical and scientific terms) used herein have the same meaning as commonly understood by one of ordinary skill in the art to which this invention belongs. It will be further understood that terms, such as those defined in commonly used dictionaries, should be interpreted as having a meaning that is consistent with their meaning in the context of the relevant art and will not be interpreted in an idealized or overly formal sense unless expressly so defined herein.

The invention generally relates to approaches for detecting and often quantifying compounds (analytes) present in a sample. Materials that can be investigated include but are not limited to components in culture media, nutrients, metabolites, enzymes, hormones, cytokines, proteins, and so forth. In illustrative examples, applications of the invention are directed to the downstream bioprocessing of mAb. Samples investigated can include more than one target analyte.

Many of the techniques described herein rely on spectroscopic approaches for determining the spectral response of sample analytes. Of particular interest is infrared spectroscopy, which generally covers the near infrared (0.75-1.4 μm, NIR), short-wavelength infrared (1.4-3 μm, SWIR), mid-wavelength infrared (3-8 μm, MWIR), long-wavelength infrared (8-15 μm, LWIR), and the far infrared (15-1000 μm, FIR) of the spectrum.

Probing molecular overtone and combination vibrations, NIR-SWIR spectroscopy covers a region of from 780 nanometer (nm) to 2500 nm of the electromagnetic spectrum. In a shorthand approach, this region between 780 nm to 2500 nm can be simply referred to by the abbreviation “NIR”. An overview of NIR spectroscopy can be found, for example, in an article by A. M. C. Davies in “An Introduction to Near Infrared (NIR) Spectroscopy”, www.impublications.com/content/introduction-near-infrared-nir-spectroscopy. See also, Cervera, A. E., Petersen, N., Lantz, A. E., Larsen, A. & Gernaey, K. V. “Application of near-infrared spectroscopy for monitoring and control of cell culture and fermentation”, Biotechnol. Prog. 25, 1561-1581 (2009); and Roggo Y, et al., “A review of near infrared spectroscopy and chemometrics in pharmaceutical technologies”, Journal of Pharmaceutical and Biomedical Analysis, Volume 44, Issue 3, 2007.

In many of its aspects, the invention features a system that includes a tunable laser, which can be part of a tunable laser spectrometer, and a clamshell analyzer for conducting the analysis. The system can further incorporate additional elements such as a controller, for example.

Tunable laser spectrometers will typically have a wavelength reference and a power reference. The wavelength reference allows the device to track its wavelength sweep through the tunable laser's spectral scan band. The power reference detects the instantaneous power during the sweep so that any variance in the power can be compensated to accurately resolve the absorption spectra of the material of interest.

In some implementations, the wavelength of the light generated by the laser 51 is within a region of from about 1350 to about 1800 nm, such as from about 1350 nm to about: 1400 nm, 1500 nm, 1600 nm, 1700 nm; or from about 1400 nm to about: 1500 nm, 1600 nm, 1700 nm or 1800 nm; or from about 1500 nm to about: 1600 nm, 1700 nm, 1800 nm; or from about 1600 nm to about: 1700 nm, 1800 nm; or from about 1700 nm to about 1800 nm. In other implementations, the wavelength employed is within a range of from about 2050 nm to about 2400 nm, such as from about 2050 nm to about: 2100 nm, 2200 nm, 2300 nm; or from about 2100 nm to about: 2200 nm, 2300 nm, 2400 nm; or from about 2200 nm to about: 2300 nm, 2400 nm; or from about 2300 to about 2400 nm.

The instantaneous narrow band emission from the laser is typically less than 100 nm wide, Full Width at Haft Max (FWHM). More often it is less than 50 nm wide and can be less than 25 nm wide or even less than 15 nm.

In the MIR region, the wavelength of the light from the laser 51 can be within a range of from about 3.5 microns to about 10 microns, such as from about 3.5 microns to about: 4, 5, 6, 7, 8, 9 microns; or from about 4 microns to about 5, 6, 7, 8, 9, 10 microns; or from about 5 microns to about: 6, 7, 8, 9 10 microns; or from about 6 microns to about: 7, 8, 9, 10 microns; or from about 7 microns to about: 8, 9, 10 microns; or from about 8 microns to about: 9, 10 microns; or from about 9 to about 10 microns.

For some applications the tunable laser 51 is optimized for a specific wavelength range which contains relevant, e.g., protein-critical chemical information (C—H, O—H, etc.). In one embodiment the tunable laser sweeps its wavelength in a spectral band including 2.3 micrometers in wavelength and sweeps through greater than 100 nanometers in wavelength. In one implementation, the laser employs a Gallium antimonide (GaSb) gain chip and sweeps through a spectral band extending from about 2.2 to 2.4 micrometers in wavelength.

In another example, the tunable laser 51 is optimized for longer wavelength ranges in the MIR. In one embodiment the tunable laser 51 sweeps its wavelength in a spectral band including such as from about 3.5, 4, or 5 microns to about: 6, 7, 8, or 9 microns. In one implementation, the laser employs a quantum cascade gain chip.

For high performance operations, all power variability must be fully compensated. And one source of power variability arises from the highly polarized nature of diode lasers. As a result, small changes in the polarization in conjunction with polarization dependent loss (PDL) in the different components such as lenses, beam splitters and detectors will result in an untracked power variability that will degrade the accuracy of the absorption spectra.

To ensure the polarization stability that is required to manage PDL, polarization maintaining fiber, such as polarization maintaining single mode optical (PANDA) fiber can be employed in conjunction with the tunable laser spectrometer. The use of polarization maintaining fiber, however, does not entirely solve the problem. The phenomenon of fiber polarization beat or PANDA ripple also arises because there is usually some power in the non-preferred polarization and this will beat with the power in the preferred polarization, causing power fluctuations. More generally, when two waves with different linear polarization states propagate in the birefringent polarization maintaining (PM) fiber, their phases will evolve differently. The difference in phase delay will be proportional to the fiber length.

Specific embodiments address at least some of these issues, as further described below. Details also can be found in US Patent Publication No. 2024/0117293 and International Publication WO 2024/076868, both published on Apr. 11, 2024 and both being incorporated herein by this reference.

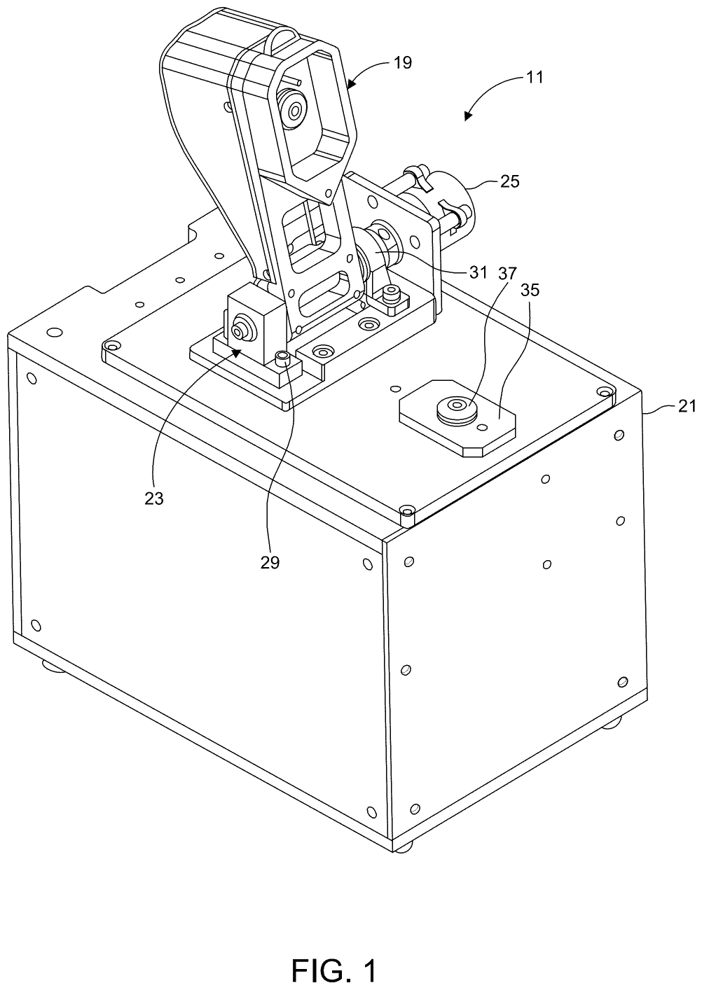

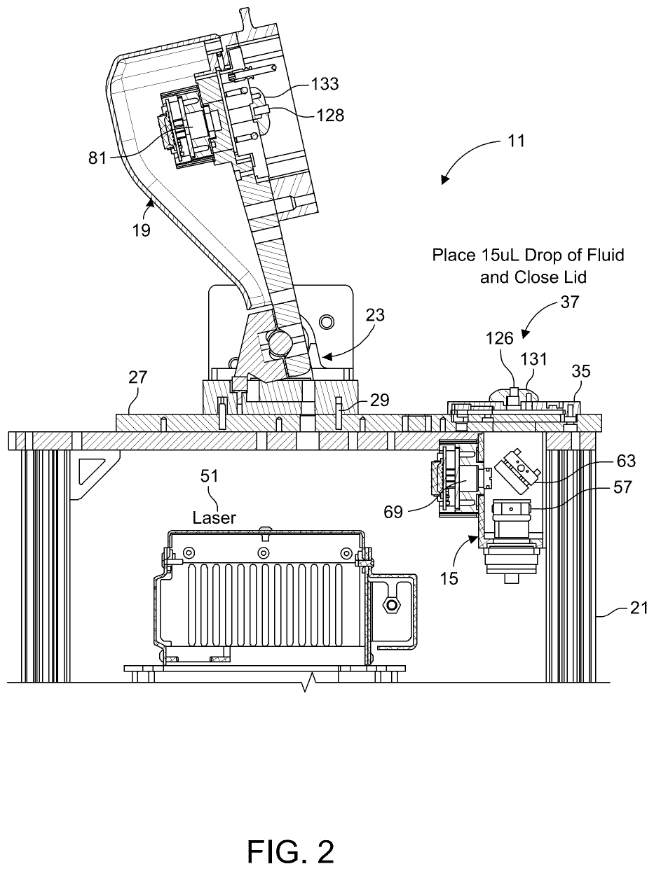

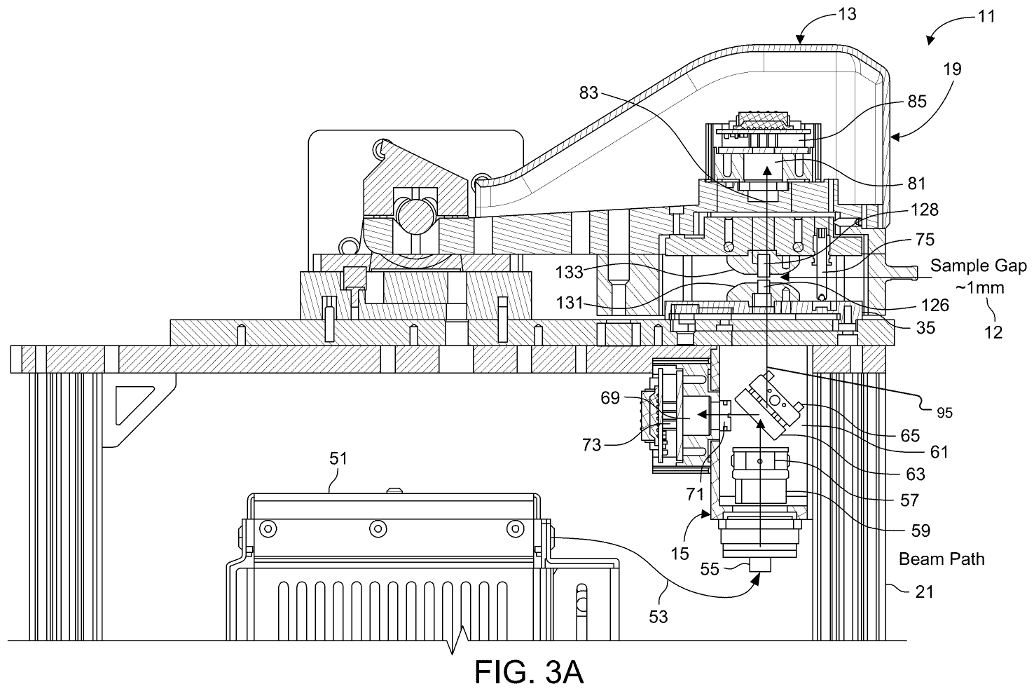

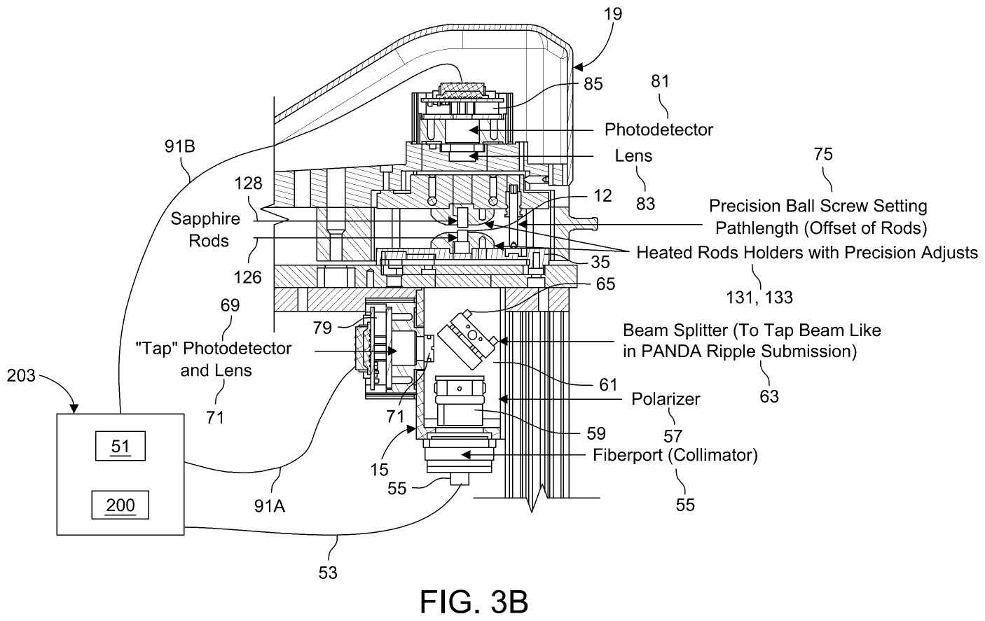

Shown in FIGS. 1 through 3C is an apparatus having a clamshell configuration. Specifically, FIG. 1 is a perspective view of a support holding a top section of a clamshell apparatus, while cross sectional views of the apparatus in the open and closed position are presented, respectively, in FIG. 2 and FIGS. 3A and 3B; FIG. 3C is a top view of one illustrative layout that incorporates a reference detector.

A component of system 11, clamshell apparatus 13 includes a first and a second section. The first section 15 is fixed and secured onto a base or support 27 and, in the current embodiment, represents the lower or bottom portion of the clamshell apparatus. In this configuration, the first section 15 hangs from support 27 and does not move or flip. Rather, the opening and closing movement is performed by the second section, section 19. In the current embodiment, second section 19 represents the upper, top or lid-like section. Other arrangements or orientations of the two sections are possible.

In more detail, shown in FIG. 1 is top section 19, supported on an enclosure or housing such as cabinet 21, and connection 23, a clam-like or “flip” arrangement, for opening and closing the apparatus. Various mechanisms can be employed to move the upper section between an open and closed configuration. For example, connection 23 can be or can include one or more of the following elements: jaws, hinges, soft close arrangements, rods, levers, or others, as known in the art. In the perspective view of FIG. 1, lowering or lifting the top section 19 relative to bottom section 15 (hidden in cabinet 21 in the perspective view of FIG. 1) is performed by a knob, rod and soft close feature 25. Some approaches can provide a lip for lifting or lowering section 19, with the connection including a hinge mechanism, for example. In general, connection 23 can be constructed using elements and techniques known in the art.

In some implementations, connection 23 joins the two sections directly. For instance, this connection can be supported onto the fixed first section and can include a mechanism that allows attachment of the second section and its movement between an open and a closed configuration. Other implementations rely on an additional component for supporting connection 23 or components thereof. For instance, support 27 can be used to position top section 19 onto a structure (e.g., on an upper surface of cabinet 21, in FIG. 1, or, in other arrangements, on a platform, bench, table, etc.), to ensure precision mating of the top and bottom sections when in the closed configuration. Bolts 29 or another type of locking means can be employed. In the example shown, base 27 incorporates or supports hinge 31, an illustrative element of connector 23.

Also present at support 27 is sample pedestal 35, which includes sample receiving region 37. During operation, section 19 can be opened, to receive a sample, in the form of a drop, for instance, then closed, much like a lid, for the sample analysis.

Light from the tunable laser can be transmitted to apparatus 13 via fiber optics. Electrical signals obtained from the photodetector(s) employed can be collected from apparatus 13 and transmitted to a tunable laser spectrometer via cables, using one or more wire harnesses, for example. The tunable laser, along with a controller, can be part of a tunable laser spectrometer. Some or all these components (e.g., fiber optics and/or electrical cables that are external to the clamshell apparatus 13), tunable laser, controller, as well as section 15 or a portion thereof) can be enclosed in cabinet 21. Principles (e.g., form factor, beam alignment) described herein can be used or adapted for tunable visible/ultraviolet tunable lasers, quantum cascade lasers (QCL) or other lasers, as known in the art or developed in the future.

Illustrative implementations of the system and apparatus of the invention are further described with reference to FIG. 2 (open configuration of the clamshell apparatus 13) and FIGS. 3A and 3B (closed configuration of apparatus 13).

Following a light beam generated by tunable laser 51 and transmitted via an optical fiber arrangement such as optical fiber patch cable 53, light enters section 15 of apparatus 13 at fiberport 55. The tunable laser generates light in the wavelengths described above. It is also possible to employ a UV/visible tunable laser, a QCL laser or another suitable laser. In some implementations, fiber patch cable 53 is PANDA fiber. Fiberport 55 can be configured as a collimator for light that exists the optical fiber patch cable and is directed to polarizer 57 (for filtering and removing the light in the orthogonal polarization). A rotational mount 59 allows for the rotation of polarizer 57 in a plane that is orthogonal to bench 61 and orthogonal to the optical axis of the beam exiting from the fiber. In some implementations, mount 59 provides fine rotational adjustment of the polarizer 57 so that it can be aligned to the preferred polarization axis of the PANDA fiber.

A beam splitter (see, e.g., US 2024/0117293 or WO 2024/076868, both being incorporated herein by this reference) includes a partially reflecting sapphire window 63, such as a wedge window, held on a pitch yaw mount 65 that secures the window 63 to the bench 61. The partially reflecting sapphire window 63 reflects a portion of the beam, referred to herein as a “reference” beam, to a ripple reference photodetector 69, such as an In—GaAs detector. A focusing lens 71 couples the beam onto the active area of the ripple reference detector 69. In addition to holding the window 63, the pitch yaw mount 65 allows the adjustments of the free space beam reflected and transmitted through the sapphire window 63 so that the beam will propagate to strike the active area of the ripple reference detector 69.

The ripple detector is mounted to a head printed circuit board (PCB) 73, which includes a transimpedance amplifier to amplify the electrical response of the ripple reference detector. A thermistor can be provided on the head printed circuit board to allow for temperature compensation of the detector 69 and transimpedance amplifier. The response of the ripple reference photodetector can then be transmitted as an electrical signal to tunable laser spectrometer 203 via electrical connection 91A, in an electrical wiring harness arrangement, for example.

In addition to the reference beam, the beam splitter generates a second beam portion, referred to herein as an “input” or “interrogation” beam. This beam propagates from partially reflecting sapphire window 63 towards a sample detection region 12, defined by an optical transmission port and an opposed optical detection port. In the current example, the optical transmission port is formed by a quartz or sapphire input rod 126 and the optical detection port is formed by a quartz or sapphire output rod 128. The rod waveguide arrangement described herein obviates the need for cuvettes, a component typical of existing instrumentation.

In some implementations, rods 126 and 128 are held in rod holders 131 and 133, respectively. One or both rod holders can be heated.

Shown in FIG. 3C is a right-angle optical arrangement in which fiber port 55 and thus the light entering section 15 are disposed at an angle (typically 90°) compared to the straight on arrangement shown in FIGS. 3A and 3B, for example, in contrast to the straight tap (see, e.g., FIGS. 3A and 3B) which necessitates adjusting both detectors simultaneously with the fiberport. With the right angle approach the interrogation beam 95 direction is adjusted using a fold mirror 92 mounted on kinematic mount 93, which is secured to bench 61.

In addition, the fiber port 55 is secured to section 15 and thus the bench 61 by a goniometer 91. This allows the angle of the PANDA fiber to be adjusted to be properly aligned to the axis of polarizer 57.

As illustrated in FIGS. 2 and 3A and 3B, input rod 126 is disposed at the sample pedestal 35, while output rod 128 is part of section 19 of clamshell apparatus 13. The open position (FIG. 2) allows introducing a sample (or, for calibration purposes, a blank) onto rod 126 at sample pedestal 35. Moving section 19 to a closed position brings the two rods in alignment; the distance between their ports defines the pathway travelled by the input (interrogation) beam through the sample gap. Precision ball screw 75, extending from one end located in section 19 to sample pedestal 35, can be used to offset the rods and set the pathway to a fixed pathlength.

The selected pathlength can have a value within a range of from about 0.010 millimeters (mm) to about 5 mm or, in some cases, to about 10 mm, such as, for example, within a range of from about 0.01 mm to about: 0.05 mm, 0.1 mm, 0.5 mm, 1 mm, 2 mm, 3 mm, 4 mm, 5 mm, 6 mm, 7 mm, 8 mm, 9 mm, 10 mm; or from about 0.05 mm to about: 0.1 mm, 0.5 mm, 1 mm, 2 mm, 3 mm, 4 mm, 5 mm, 6 mm, 7 mm, 8 mm, 9 mm, 10 mm; or from about 0.1 mm to about: 0.5 mm, 1 mm, 2 mm, 3 mm, 4 mm, 5 mm, 6 mm, 7 mm, 8 mm, 9 mm, 10 mm; or from about 0.5 mm to about: 1 mm, 2 mm, 3 mm, 4 mm, 5 mm, 6 mm, 7 mm, 8 mm, 9 mm, 10 mm; or from about 1 mm to about: 2 mm, 3 mm, 4 mm, 5 mm, 6 mm, 7 mm, 8 mm, 9 mm, 10 mm; or from about 2 mm to about: 3 mm, 4 mm, 5 mm, 6 mm, 7 mm, 8 mm, 9 mm, 10 mm; or from about 3 mm to about: 4 mm, 5 mm, 6 mm, 7 mm, 8 mm, 9 mm, 10 mm; or from about 4 mm to about: 5 mm, 6 mm, 7 mm, 8 mm, 9 mm, 10 mm; or from about 5 mm to about: 6 mm, 7 mm, 8 mm, 9 mm, 10 mm; or from about 6 mm to about: 7 mm, 8 mm, 9 mm, 10 mm; or from about 7 mm to about: 8 mm, 9 mm, 10 mm; or from about 8 mm to about: 9 mm, 10 mm; or from about 9 mm to about 10 mm.

One illustrative pathlength is about 5 mm. Another illustrative pathlength is 1 mm. For MIR systems, the pathlengths can be reduced, to about 100 microns, for instance.

In specific implementations, the rods have a diameter within a range from about 2 to about 8 millimeter (mm), e.g., about 4 mm. This arrangement can hold a drop of about 15 microliter (mL) through surface tension, while allowing a beam of between 0.5 and 3 mm in diameter, preferably about 1 mm, to progress through the rods and the sample in the sample gap 12. In many cases, both rods have the same diameter. In others, the rods have different diameters. In one example, the base window (e.g., rod 126) is larger in diameter. to allow for easier cleaning. Other rod dimensions can be selected.

Output rod 128 optically couples to a sample photodetector 81, provided with lens 83. The electrical signal registered by the photodetector 81 can be transmitted to tunable laser spectrometer 203 via electrical connection 91B, e.g., in a wire harness arrangement. In one example, the photodetector is a dome lens TO-46 In—GaAs detector which can be electrically connected to a sample detector printed circuit board (PCB) 85. The detector PCB can include its own transimpedance amplifier for amplifying the detector response and transmitting that response to tunable laser spectrometer 203. A thermistor can be included on the detector PCB to detect the temperature allowing temperature offsets.

During operation, the swept wavelength light from the tunable laser 51 is coupled into the optical fiber patch cable 53 to section 15 of clamshell apparatus 13. The PANDA fiber optical fiber patch cable operates to reject modes, minimize ripple. Short fiber patch cable lengths reduce or minimize losses. Polarizer 57 further removes modes and random polarization fluctuations and addresses polarization dependent loss in the optical components. The ripple reference detector can improve operations by addressing random power attenuation. Polarizing the light removes the risk of polarization dependent loss in the optical components. A portion of the polarized light is detected by the ripple reference photodetector 69. This ripple reference signal is transmitted back to the tunable laser spectrometer 203 (see connection 91A in FIG. 3B) via a spectrometer electrical wiring harness, for example.

The remaining light travels toward and is coupled into input rod 126 exiting out the optical transmission port. It then propagates through the sample detection region 12. The light leaves the sample detection region 12 through the optical detection port and propagates through the output rod 128. It is detected by the sample photodetector 81 after being modulated by analytes in the sample detection region 12. The analytes will preferentially absorb some wavelengths relative to others.

In many cases, once it has entered the clamshell apparatus, the light beam does not need to be confined to an optical fiber but travels (from one optical element to another) in free space. As seen, for example, in FIG. 3A the arrows trace the various light pathways inside clamshell apparatus 13. In some implementations, the light beams inside the clamshell apparatus propagate without being guided by fiber optics. Other implementations can employ a combination of fiber optics and free space light propagation, while in further implementations, the light beams inside the clamshell apparatus are guided by fiber optics.

Controller 200, which can be part of the tunable laser spectrometer 203, monitors the response of the sample photodetector 81 as well as the ripple reference photodetector 65. Thus, the controller can resolve the absorption spectra of the sample by monitoring the spectral scanning of the tunable laser 51 over its scan band relative to the time-response of the sample photodetector 81. Any noise associated with ripple or other sources from the optical fiber is compensated by the response from the ripple reference photodetector 69. Generally, the tunable laser or tunable laser system sweeps its narrow band emission over some region of the electromagnetic spectrum such as the NIR and/or SWIR and/or MIR regions, or portions thereof.

In some implementations, controller 200 uses the temperatures detected by the thermistor on the PCB associated with the sample detector 81 and the thermistor associated with the reference detector 69 to compensate for change in the response of the ripple reference photodetector 69 and the sample photodetector 81 and changes in the gain of the transimpedance amplifiers on the PCBs employed.

In many optical arrangements, etalons are formed between parallel reflecting surfaces. In apparatus 13, surfaces will reflect due to the refraction index mismatch between air of the free space path of the beam and the bulk material of the input rod 126. An index mismatch between the fluid in the sample region 12, the input rod 126 and the output rod 128 can occur as well. In addition, the beam propagates through free space between the output rod 128 and detector 81. Even if surfaces are antireflection coated, residual reflectivity can still be present.

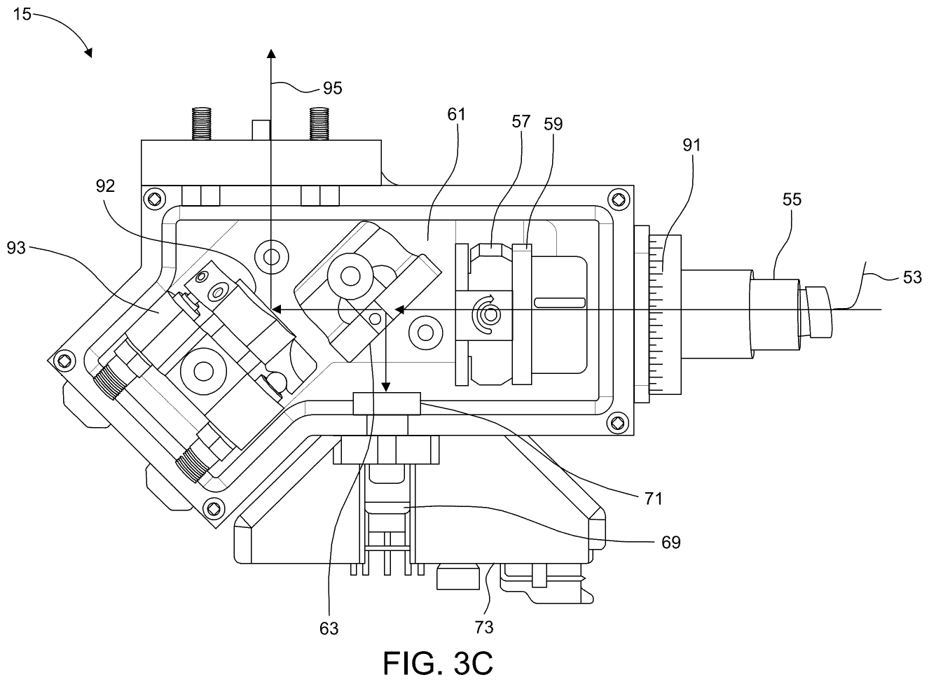

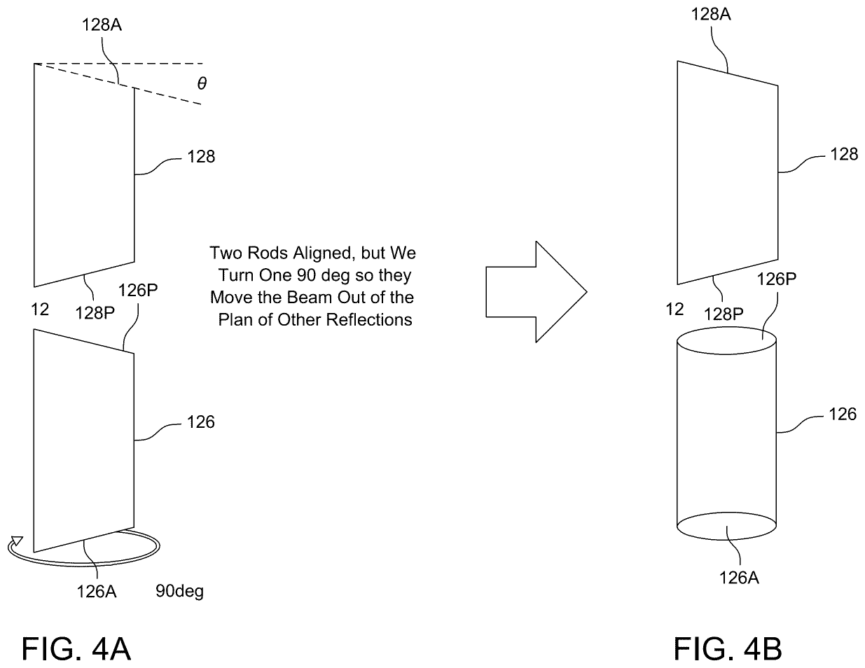

Some measures that can be taken to avoid or mitigate reflections/etalons are described with reference to FIGS. 4A, 4B, 5 and 6A through 6C.

Illustrated in FIG. 4A are input rod 126 and output rod 128, defining sample gap 12 between a transmission port 126P and a detection port 128P. Wedge angles θ are formed on ports 126A, 126P of the input rod 126, and, also, on ports 128P and 128A of the output rod 128, resulting in slanted or sloping wedged surfaces. Typically, the wedge angles θ are a few tenths of a degree, such as, for instance within a range of from about 0.09 to about 0.6 degrees. In one example, angle θ (FIG. 4A) is 0.125 degrees. In further embodiments, the angles of the input rod 126 and the output rod 128 are rotated (see circular arrow in FIG. 4A) 90 degrees relative to each other, resulting in the orientation of FIG. 4B. In this example, the ports 128A, 128P of the output rod 128 are angled left to right in the plane of the figure. The ports 126A, 126P of the input rod 126 are angled fore and aft in the plane of the figure.

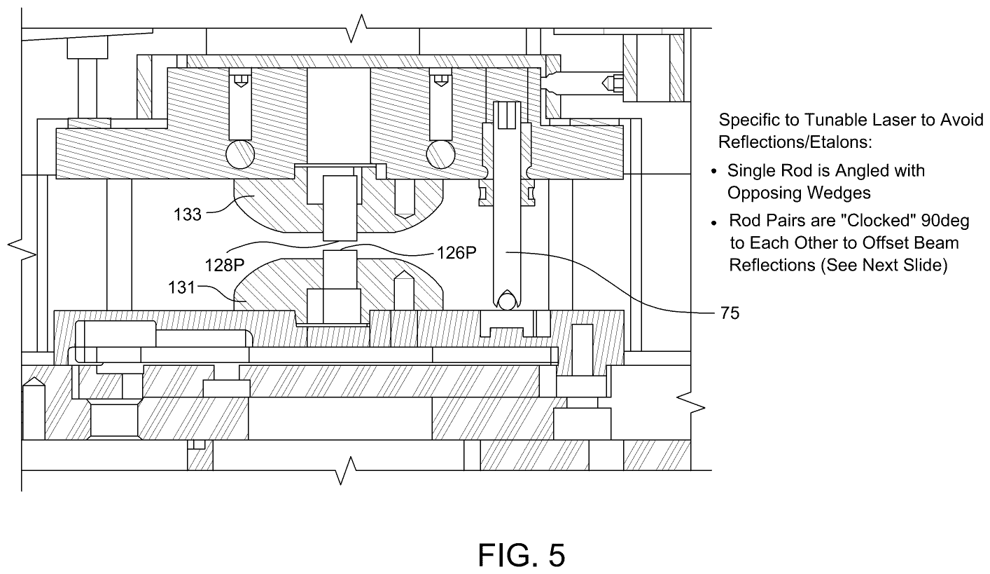

FIG. 5 is a cross sectional view of a portion of apparatus 13. The portion shown can incorporate geometric and orientation details that reduce or minimize reflections/etalons. Specifically, FIG. 5 shows a rod being angled with opposing wedges and a rod pair with rods that are “clocked” 90 degrees relative to each other, to offset reflections.

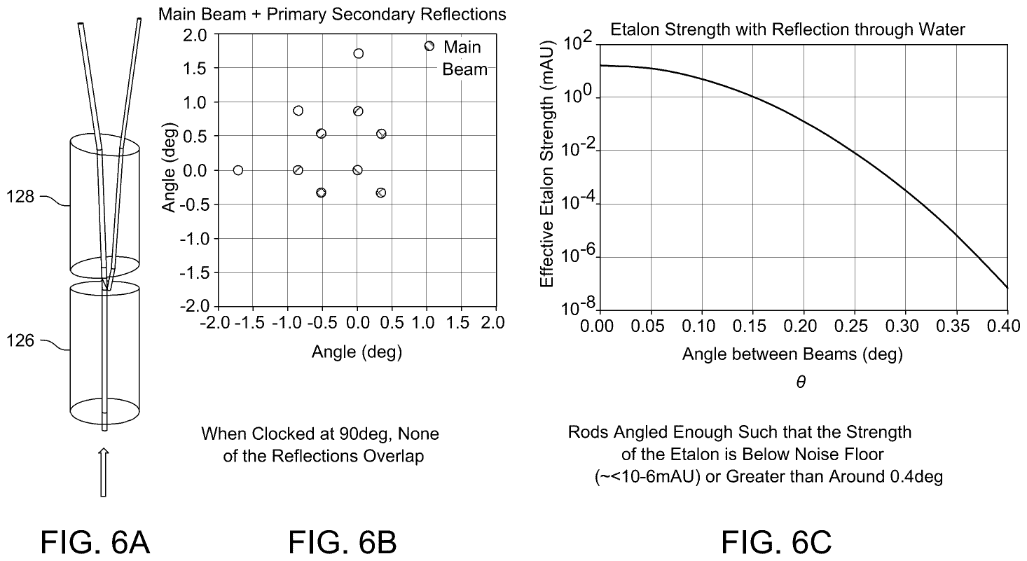

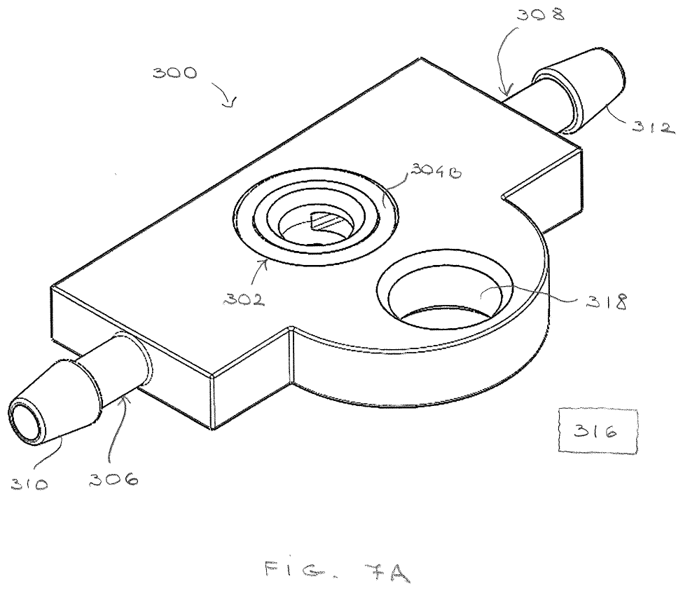

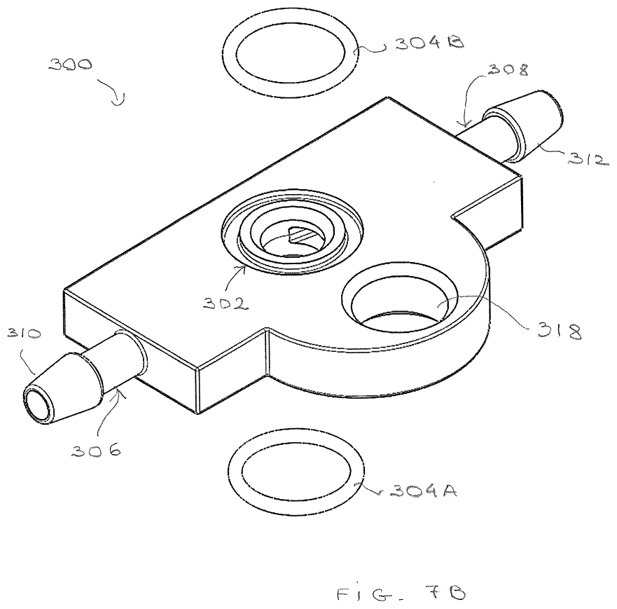

A schematic diagram of light traveling though input rod 126 then output rod 128, constructed and oriented as described above, is shown in FIG. 6A. When clocked at 90 degrees, none of the reflections overlap. This can be seen in FIG. 6B, showing no superposition (overlap) of the main beam (dark circles) and primary and secondary reflections (lighter circles). FIG. 6C presents the etalon strength with reflection through water. The rods are angled (angle θ) such that the strength of the etalon is below the noise floor, approximately less than about 10⁻⁶ mAU (milli-absorbance units) or greater than about 0.4 degrees.

A typical illustrative workflow according to the present invention involves only a few simple steps. For static measurements, the clamshell apparatus is placed in the open position and a sample (e.g., 15 μL) is pipetted onto rod 126 (e.g., a water blank, then sample) at the sample pedestal 35. The clamshell apparatus is then closed by lowering section 19 towards and onto section 15, to form the sample detection region containing the sample (or the blank). Scanning the sample can then be performed, often taking about 5 seconds per scan, followed by reading the results.

While embodiments discussed above are well suited for analyzing static samples, such as drops introduced into the sample detection region by a pipette, for example, aspects of the invention can also address analyzing flowing samples. Measurements can thus be extended to microfluidic applications, probes designed to extract and return fluid from and back to a reactor, and many other flow-based operations.

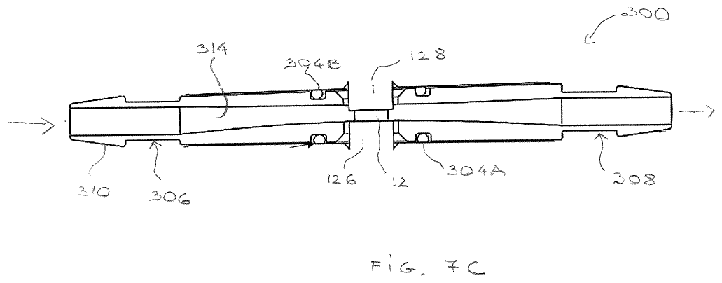

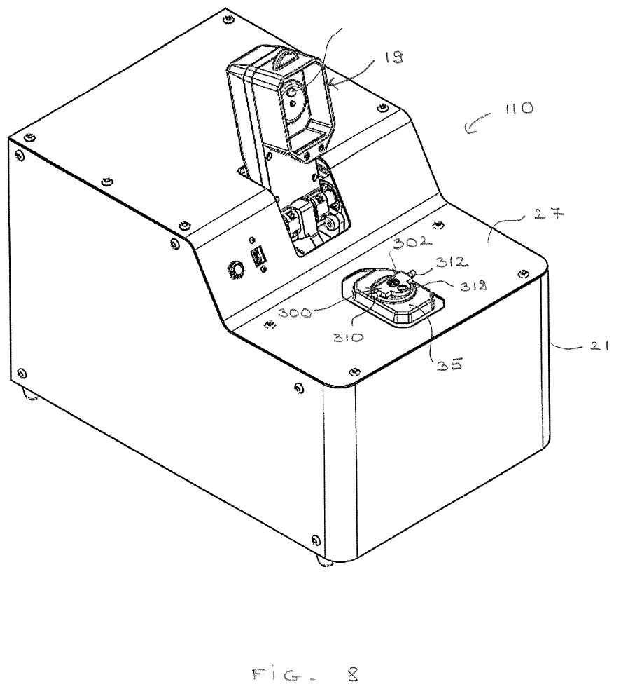

Shown in FIGS. 7A, 7B and 7C is adapter 300, typically a plate that can be inserted between the first section 15 and second section 19 of the clamshell apparatus to obtain the configurations presented in FIGS. 8 through 11. Defining a flow pathway through its body, adapter 300 can be thought of as a flowcell and is referred to herein as a “flowcell adapter” or simply as an “adapter”. The pathway includes a sample detection region, for conducting an analysis, e.g., as described above.

In more detail, adapter 300 provides orifice 302 designed to receive input rod 126 and output rod 128, these rods defining sample detection region or sample gap 12 within opening 302. In specific implementations, the rods are angled and orientated as described with reference to FIGS. 4A, 4B, 5 and 6A. The rods can be fitted in a leak-free fashion using sealing O-rings 304A and 304B.

A flowing sample is brought into and evacuated from adapter 300 via suitable tubing which can be connected to inlet 306 and/or outlet 308 using barbed fittings 310 and 312, for example. Flow is supported by channel 314, which extends to and from the sample detection region 12. In one example, the flowcell adapter is integrated and becomes part of a fluidic system that flows a sample from bioreactor.

Device 316, a suitable pump such as a peristaltic pump, for example, drives the sample movement through the channel. In some embodiments, device 316 is a component of a fluidic system. In others, it is a stand-alone element.

Hole 318 accommodates a locating feature, thus preventing any unwanted rotations of the adapter relative to sections 15 and 19 of the clamshell apparatus.

Adapter 300 can have a thickness within a range from about 5 mm to about 25 mm and can be constructed from any suitable material. Examples include metals such as stainless steel, aluminum, etc., bio-compatible plastics, e.g., polystyrene, polypropylene, or others. Channel 314 can be formed in the body of the adapter by machining, 3D printing, injection molding or other techniques.

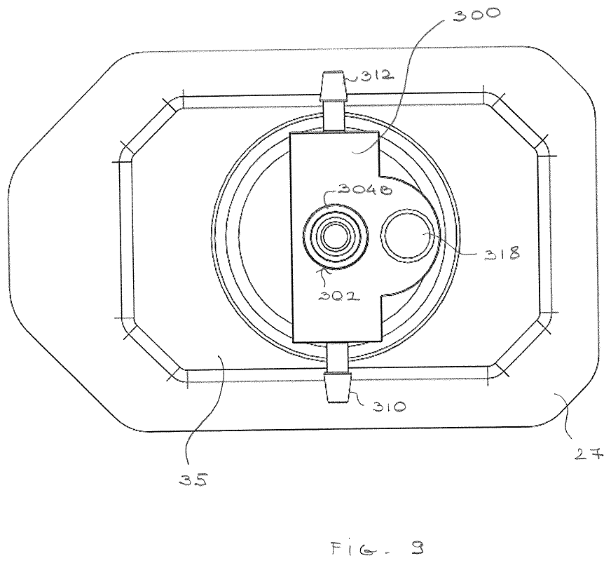

To provide flowcell functionality, the adapter is incorporated into the clamshell apparatus. Shown in FIG. 8 is configuration 110 of a clamshell apparatus that integrates adapter 300. With lid-like section 19 in the open position, adapter 300 can be placed on sample pedestal 35 located on support 21. A top view of adapter 300 on sample pedestal 35 is presented in FIG. 9.

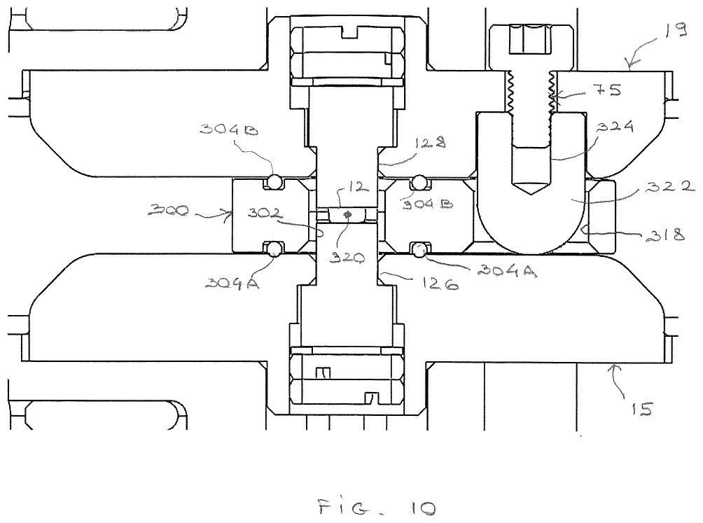

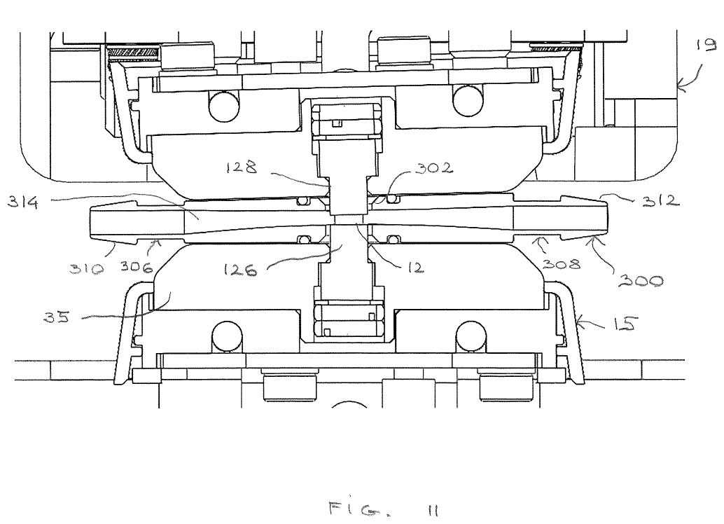

For analyzing a flowing sample, the clamshell apparatus is placed in its closed position. Side and front sectional views of adapter 300, sandwiched between the two sections of the apparatus are presented, respectively, in FIGS. 10 and 11.

Shown in FIG. 10 is adapter 300 inserted between section 15 and section 19 of the clamshell apparatus in its closed position. As described, O-rings 304A and 304B can be used to provide a leak-free seal. A sample flowing through channel 314 follows flow pathway 320. Measurements are taken in sample gap 12, between rods 126 and 128.

Securing the flowcell adapter between section 15 and section 19 can be realized through a locking arrangement. In the closed configuration illustrated in FIG. 10, for instance, hole 318 receives locating feature 322. Locking the locating feature 322 into corresponding hole 318 prevents unwanted rotations of adapter 300 during operation, or as section 19 is being closed.

In one example, locating feature 322 passes through hole 318 and contacts pedestal 35. An end portion 324 of precision ball screw 75 fits into the locating feature, pushing or liftings it to offset the rods and establish the fixed pathlength.

The front sectional view of FIG. 11 shows adapter 300 inserted between sections 15 and 19 of the clamshell apparatus. As before, O-rings can provide a leak-tight seal between the adapter and each of the two sections. In the closed configuration of FIG. 11, rods 126 and 128 fit through orifice 302 defining sample gap 12.

During operation, a sample enters adapter 300 at input 306, flows through channel 314, reaches sample detection region 12, for measurements, continues along channel 314 and exits the adapter at output 308.

Measurements can be obtained on a continuously flowing sample. Intermittent flow can be used in some cases. For instance, the sample flow can be stopped for a time interval (e.g., needed to scan the sample), then restarted.

In one embodiment, flow parameters are monitored and/or adjusted by controller 200 (see, e.g., FIG. 3B). Other suitable approaches can be employed. If integrated into an overall fluidic system, for example, the sample flow can be monitored and/or controlled by the same equipment employed to move fluid through the fluidic system.

Adding a flow cell can result in a clamshell apparatus dedicated entirely to the analysis of flowing samples. In such a situation, adapter 300 can be a permanent component of the clamshell apparatus. A detachable adapter, however, can be incorporated into the apparatus as a simple add-on feature, to be used as and when needed. Switching from a static to a flow regime can be made by tube connections to inlet 306 and outlet 308 of adapter 300, without deeper modifications of the apparatus. Similarly, tubing can be disconnected, and/or the adapter can be removed, returning the clamshell apparatus to static measurements mode. In some situations, for repeated measurements, for instance, adapter 300 can be fitted in a line used in process operations conducted in fluid mode.

A workflow protocol for switching between a static to a flowing sample may involve some or all of the following steps: placing adapter 300 onto pedestal 35 while the clamshell apparatus is in its open position (as shown, e.g., in FIG. 8); connecting tubing at inlet 306 and outlet 308; closing the apparatus, preferably taking advantage of locking features implemented to prevent unwanted rotations; initiating flow and conducting measurements on continuously or intermittently moving fluid (sample or blank), essentially as described above.

To return the apparatus to static measurements, flow can be stopped, lid 19 can be opened, and the adapter and related tubing can be removed, freeing pedestal 35 and rod 126 to receive a sample (e.g., a drop from a pipette) and conduct a measurement on the static sample.

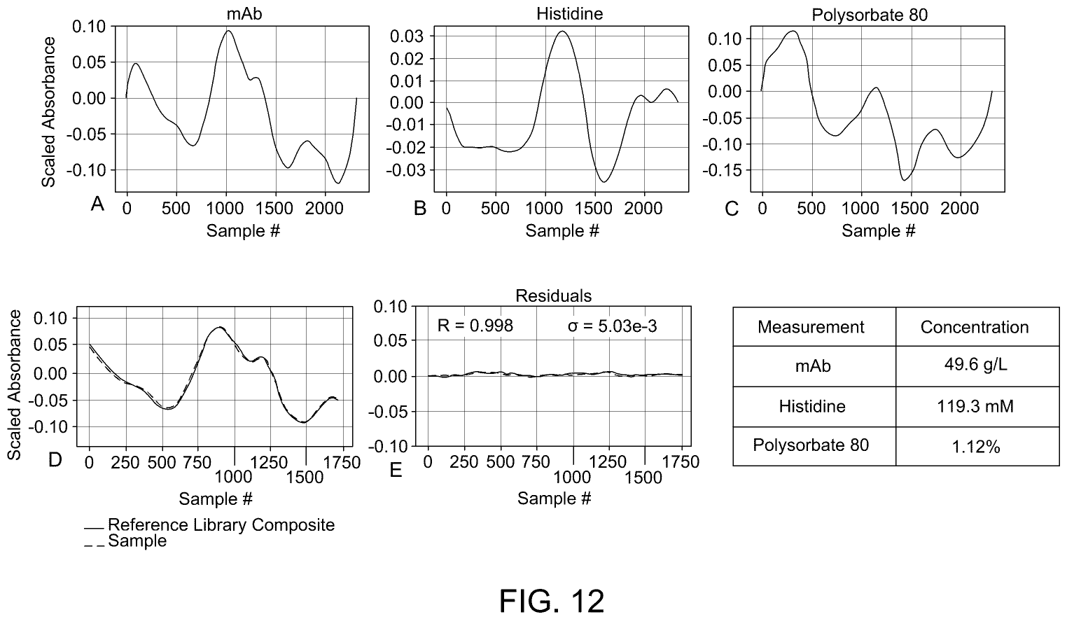

In many embodiments, the results are automatically analyzed and displayed on a suitable viewer, as illustrated in FIG. 12, showing the scaled absorbance of the following sample components: mAb (A), histidine (B) and polysorbate (C); a comparison between the sample and a reference library composite (D); and the scaled absorbance of residuals (E). The various components can be measured simultaneously, providing mAb as well as excipient data in a single scan.

Embodiments of the invention are further described in the following non-limiting examples.

### Example 1

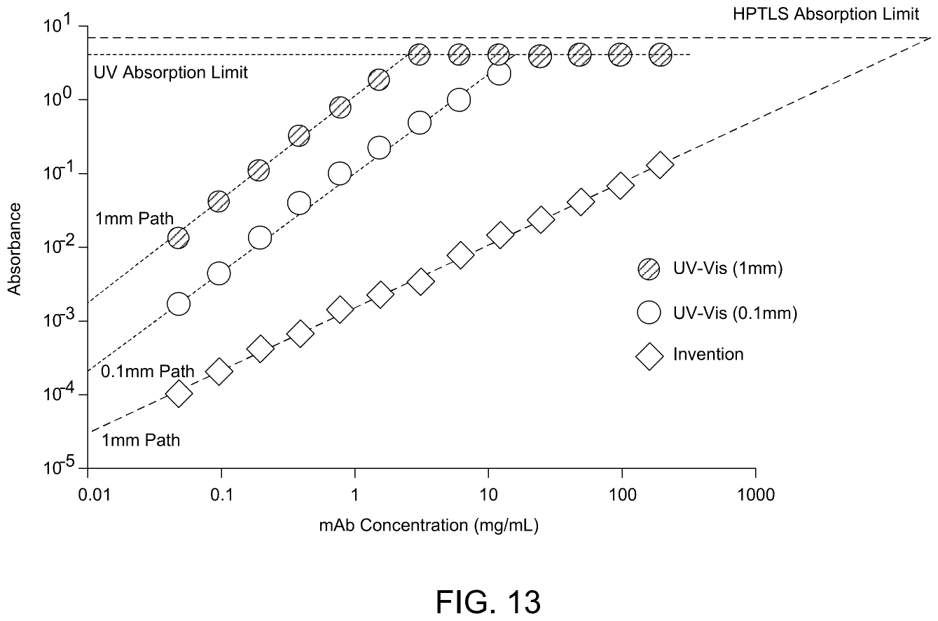

As already noted, an application of interest relates to protein measurements. Techniques described herein can operate in a wavelength range where mAb absorbs two orders of magnitude lower than in the UV region and has a maximum absorption of about 5 AU), resulting in a two orders of magnitude higher upper limit of detection compared to UV measurements. This is illustrated in FIG. 13 (showing a comparison between UV-visible results at 1 mm and 0.1 mm light pathway, with results according to embodiments of the invention at 1 mm pathway). Due to a superior SNR and sensitivity, it is also possible to achieve a lower limit of detection around 0.01 mg/mL, therefore providing a very wide dynamic range relative to other current optical methods.

The set-up used to obtain the data discussed below utilized a tunable laser developed for a specific wavelength range which contains relevant, protein-critical chemical information (C—H, O—H, etc.) and a NISTmAb reference material. Application of embodiments of the invention confirmed spectral identity and qualified sample concentration with a high correlation coefficient (>0.99) to the reference material.

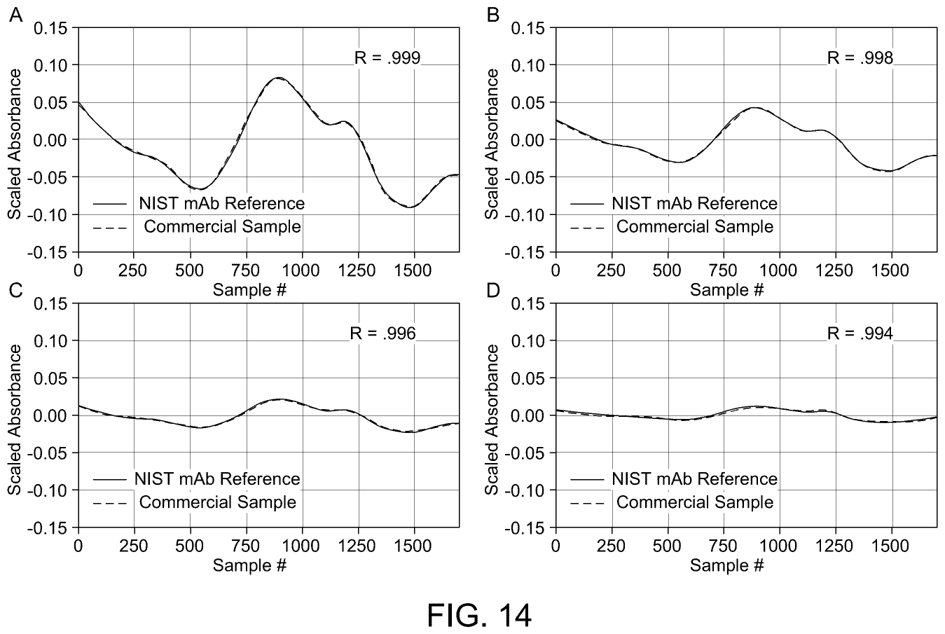

Observed in FIG. 14 is the spectral signature of a commercial mAb at 100 mg/mL (A) which is identical to the NISTmAb (10.03 mg/mL) and scales through dilutions (B, C and D). In more detail, user samples were compared to the NISTmAb reference material. Instant statistics were performed to qualify a measurement. The measured (and actual) concentrations for samples A-D were 99.39 (100), 49.9 (50), 25.6 (25) and 12.7 (12.5) mg/mL, respectively.

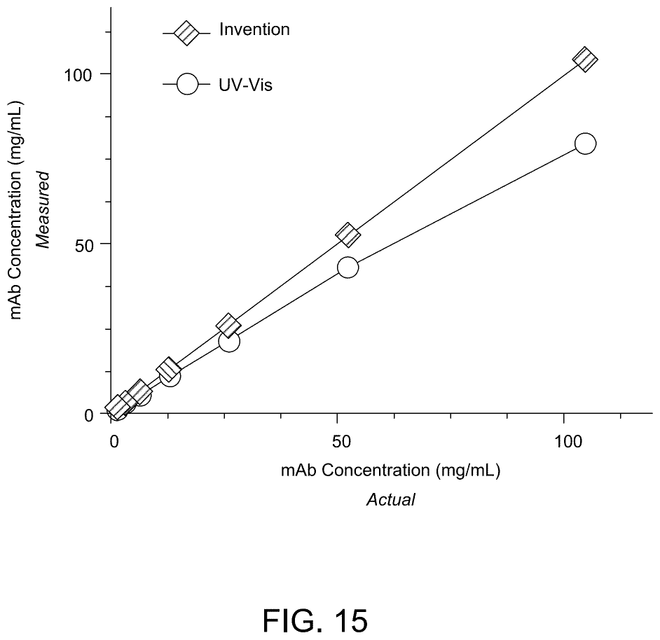

Measurements of mAb in the presence of excipients employed mAb in a histidine, poly80 buffer (5 mg/mL histidine+1 mg/mL poly80). FIG. 15 shows that UV analysis yielded an error of about 20%, while the error seen with techniques described herein was only about 1% through all dilutions.

### Example 2

A clamshell system such as described above was used to measure different species of amino acids present in a buffer. The general protocol was as follows: 1) pipette 15 μL of deionized water (DI) water on the pedestal and scan; 2) clean with Kimwipe™; 3) pipette 15 μL of sample (of known concentration) and scan; and 4) select analytes for quantitation, run analysis and obtain the results.

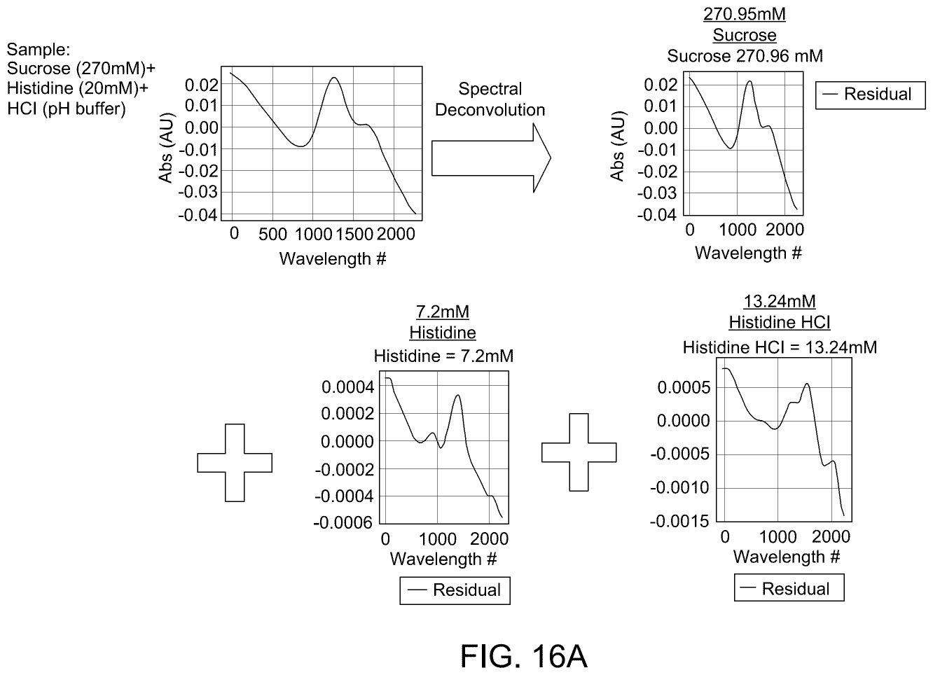

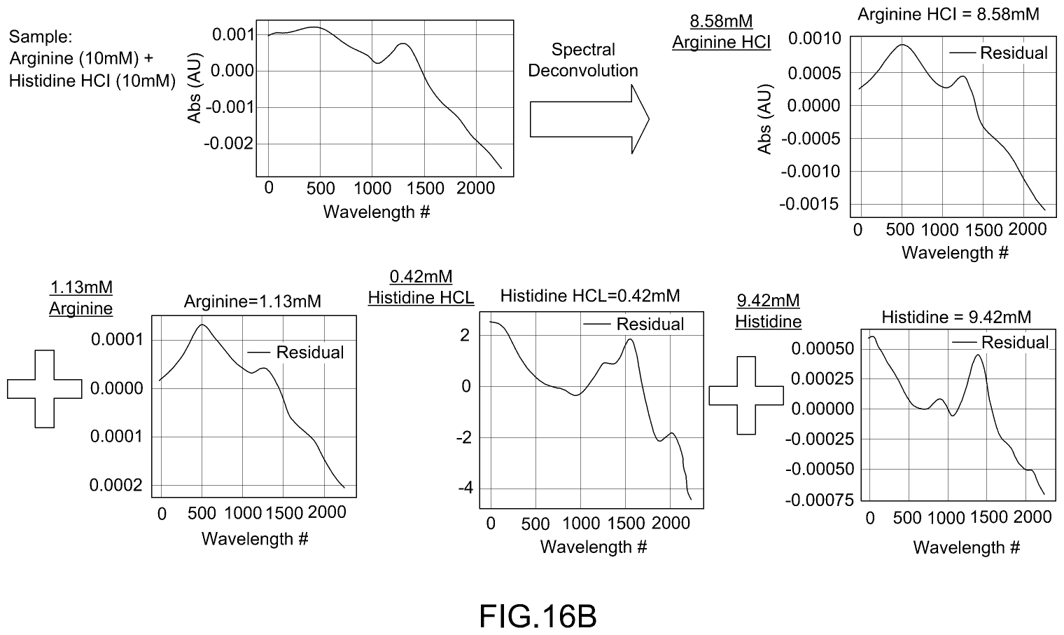

FIG. 16A shows the on-demand excipient analysis for buffer verification of a sample containing sucrose 270 mM), histidine (20 mM) and HCl (used as a pH buffer). The spectral deconvolution showed the presence of histidine and histidine HCl (which represent the two species, namely the different protonated forms of histidine around its pKa of 6.0) and demonstrated that it was possible to measure histidine and histidine HCl simultaneously. In more detail, the results verified the sucrose concentration of 270 mM and detected 7.2 mM of histidine and 13.24 mM of histidine HCl.

Shown in FIG. 16B are the spectral deconvolution measurements showing the concentration of arginine HCl, arginine, histidine HCl and histidine in a sample containing 10 mM arginine and 10 mM histidine HCl.

### Example 3

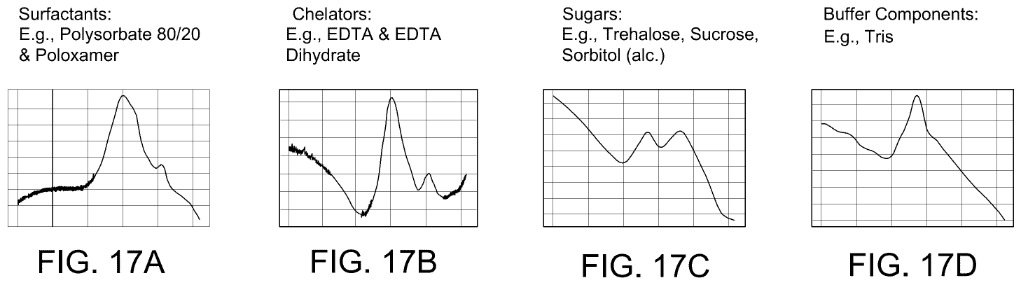

FIGS. 17A through 17D show illustrative measurements of complex buffer components such as surfactant species, chelating compounds, specific sugars, or other buffer components.

While this invention has been particularly shown and described with references to preferred embodiments thereof, it will be understood by those skilled in the art that various changes in form and details may be made therein without departing from the scope of the invention encompassed by the appended claims.

What is claimed is:

1. A system for analyzing a sample, the system comprising:
a tunable laser spectrometer for generating a swept wavelength signal;
a clamshell apparatus defining a sample detection region and including a reference photodetector for detecting the swept wavelength signal from the tunable laser spectrometer and a sample photodetector for detecting the swept wavelength signal after transmission through the sample detection region; and
a flowcell adapter defining a channel for passing a flowing sample to and from the sample detection region,
wherein the clamshell apparatus has a first fixed section and a second section configured for movement between an open and a closed position of the clamshell apparatus.

2. The system of claim 1, wherein the reference photodetector is in the first fixed section of the clamshell apparatus and the sample photodetector is in the second section of the clamshell apparatus.

3. The system of claim 1, further comprising a beam splitter for directing a reference beam to a reference photodetector and an interrogation beam to the sample photodetector.

4. The system of claim 1, further comprising a polarizer.

5. The system of claim 1, wherein the sample detection region is defined between a transmission port of an input rod and a detection port of an output rod.

6. The system of claim 1, further comprising a locking arrangement for securing the flowcell adapter to the first fixed section of the clamshell apparatus.

7. The system of claim 1, wherein the clamshell apparatus further includes a device for adjusting or maintaining a distance between the transmission port and the detection port.

8. The system of claim 1, wherein at least one light beam propagates through the clamshell apparatus without being guided by fiber optics.

9. The system of claim 1, further comprising a controller.

10. The system of claim 1, wherein the flowcell adapter is part of a fluidic system.

11. A method for analyzing a sample, the method comprising:
passing a flowing sample through a sample detection region formed in a closed configuration of a clamshell apparatus;
generating a swept wavelength signal;
transmitting the swept wavelength signal to a first section of a clamshell apparatus;
detecting the swept wavelength signal in the clamshell apparatus prior to transmission through the sample detection region;
detecting the swept wavelength signal after transmission through the flowing sample in the sample detection region; and
resolving an absorption spectra of the sample with reference to the swept wavelength signal before and after transmission through the sample detection region.

12. The method of claim 11, wherein the swept wavelength signal is generated by a tunable laser and is within a range of from about 1350 to about 1800 nm, or within a range of from about 2050 to about 2400 nm, or within a range of from about 3.5 to about 10 microns.

13. The method of claim 11, further comprising opening or closing the clamshell apparatus.

14. The method of claim 11, wherein the flowing sample is directed to the sample detection region through a channel defined in a flowcell adapter.

15. The method of claim 11, further comprising inserting or removing a flowcell adapter into or from the clamshell apparatus.

16. The method of claim 10, further comprising securing a flowcell adapter to a fixed section of the clamshell apparatus.

17. The method of claim 10, further comprising attaching a flowcell adapter to tubing for directing the sample to or from a flowcell adapter.

18. The method of claim 10, wherein detecting the swept wavelength signal prior to transmission through a sample detection region takes place in a fixed portion of the clamshell apparatus and detecting the swept wavelength signal after transmission through a sample in the sample detection region takes place in a lid section of the clamshell apparatus.

19. The method of claim 10, further comprising passing the swept wavelength signal through a polarizer before detecting it as a reference signal.

20. The method of claim 10, further comprising controlling flow parameters of the sample.

21. A clamshell apparatus, comprising:
a first section including a polarizer, a beam splitter and a reference photodetector;
a second section including a sample photodetector;
an input rod having a transmission port and an output rod having a detection port,
a flowcell adapter for directing a flowing sample to and from a sample detection region, the sample detection region being defined by the transmission port and the detection port of the clamshell apparatus in a closed configuration.

22. The clamshell apparatus of claim 21, further comprising a locking arrangement for securing the flowcell adapter to the first fixed section of the clamshell apparatus.

23. The apparatus of claim 21, wherein the first section is fixed and the second section is configured for moving between an open and a closed position.

24. The apparatus of claim 21, further comprising a device for adjusting or maintaining a distance between the transmission port and the detection port.

25. The apparatus of claim 21, wherein the flowcell adapter is part of a fluidic system.

26. A flowcell adapter for a system for analyzing a sample, the system comprising a tunable laser spectrometer for generating a swept wavelength signal and an apparatus defining a sample detection region and including a reference photodetector for detecting the swept wavelength signal from the tunable laser spectrometer and a sample photodetector for detecting the swept wavelength signal after transmission through the sample detection region; wherein the flowcell adapter defines a channel for passing a flowing sample to and from the sample detection region.
